(19) United States
(12) Patent Application Publication
(10) Pub. No.: US 2012/0319656 A1
(43) Pub. Date: Dec. 20, 2012

(54) POWER CONTROL APPARATUS AND POWER CONTROL METHOD

(76) Inventors: Hideyuki Toma, Kodaira-shi (JP); Fumihiko Murakami, Yokohama-shi (JP)

(21) Appl. No.: 13/356,285

(22) Filed: Jan. 23, 2012

(30) Foreign Application Priority Data
Jun. 14, 2011 (JP) 2011-132402

(51) Int. Cl. H02J 7/00

(52) U.S. Cl. 320/134

(57) ABSTRACT

According to one embodiment, a power control apparatus includes a power supply module and a controller. The power supply module is configured to supply, to a power supply destination, externally supplied external power or battery power from a battery which is configured to be chargeable by the external power. The controller is configured to supply the battery power in response to a battery-drive instruction, stop, upon detecting that a voltage of the battery power is less than a reference voltage, supply of battery power, and control supply of the external power and charging of the battery by the external power according to a control condition.

### CROSS-REFERENCE TO RELATED APPLICATIONS

This application is based upon and claims the benefit of priority from prior Japanese Patent, Application No. 2011-132402, filed Jun. 14, 2011, the entire contents of which are incorporated herein by reference.

### FIELD

Embodiments described herein relate generally to a power control apparatus and a power control method.

### BACKGROUND

An electronic apparatus incorporating a battery can operate by external power, or it can operate by battery power from the battery even if external power is not supplied. Such electronic apparatus includes a portable computer and a portable digital TV.

If an electronic apparatus incorporating a battery operates by battery power, and a shortage of the remaining battery level occurs, the operation by the battery power cannot continue. In this case, the electronic apparatus can operate by external power in place of the battery power. If a shortage of the remaining battery level occurs, the electronic apparatus can charge the battery by external power.

Depending on the situation, however, it may be desirable not to switch the battery power to the external power when a shortage of the remaining battery level occurs. Also, it may be desirable not to automatically charge the battery when a shortage of the remaining battery level occurs.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary block diagram showing a representative overall configuration of a television receiver that incorporates an embodiment;

FIG. 2A and FIG. 28 are exemplary diagrams outlining a representative configuration of a remote controller;

FIG. 3 is an exemplary flowchart explaining how the television receiver of FIG. 1 operates;

FIG. 4A, FIG. 48 and FIG. 4C are diagrams, respectively showing an exemplary message and exemplary icons the television receiver of FIG. 1 may display;

FIG. 5 shows an example of the time at which the reception state is switched from the full-segment receiving state to the one-segment receiving state, and an example of the time at which the image is actually switched from the full-segment image to the one-segment image;

FIG. 6A, FIG. 6B, FIG. 6C, FIG. 6D and FIG. 6E show exemplary images of the display while the television receiver of FIG. 1 is set in the power saving mode;

FIG. 7A and FIG. 7B show an exemplary structure of the backlight unit of the display of the television receiver of FIG. 1;

FIG. 8A and FIG. 8B show another structure the backlight unit of the display of the television receiver of FIG. 1 may have;

FIG. 9A and FIG. 9B show an exemplary power-saving menu the display of the television receiver of FIG. 1 may display, helping the user to set a power-saving function at the remote controller; and

FIG. 10 is a flowchart illustrating an example of power control by the television receiver shown in FIG. 1.

### DETAILED DESCRIPTION

Various embodiments will be described hereinafter with reference to the accompanying drawings.

In general, according to one embodiment, a power control apparatus includes a power supply module and a controller. The power supply module is configured to supply, to a power supply destination, externally supplied external power or battery power from a battery which is configured to be chargeable by the external power. The controller is configured to supply the battery power in response to a battery-drive instruction, stop, upon detecting that a voltage of the battery power is less than a reference voltage, supply of battery power, and control supply of the external power and charging of the battery by the external power according to a control condition.

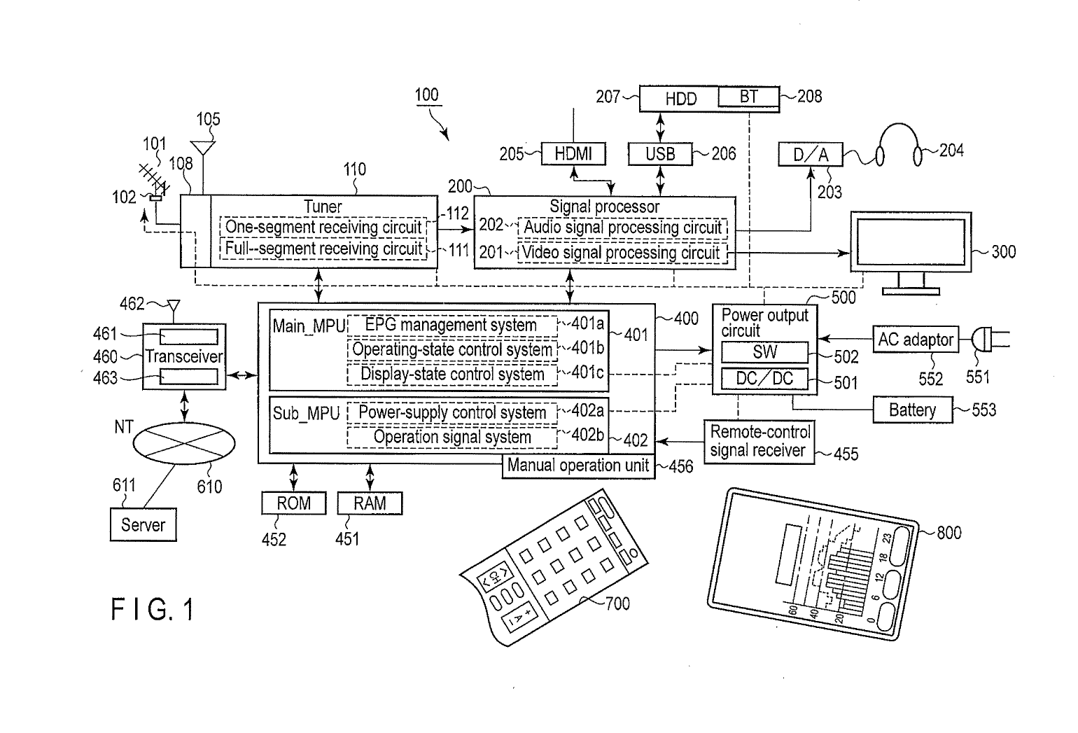

FIG. 1 shows a stationary television receiver 100 to which the embodiment is applied. A UHF antenna 101 can catch terrestrial television broadcast waves. Power is supplied to the booster 102 of the antenna 101. The existing terrestrial digital broadcasting system can transmit a twelve-segment (it may be referred to a full-segment or a full-seg) broadcast signal and a one-segment (it may be referred to one-seg) broadcast signal. The UHF antenna 101 is used to receive the full-segment broadcast signal. An indoor antenna 105 is used to receive the one-segment broadcast signal.

The UHF antenna 101 may also be referred to an “external antenna” or “outdoor antenna.” The indoor antenna 105 may also be referred to an “internal antenna.”

The UHF antenna 101 can be connected to a tuner 110 via an antenna connection board 108. The indoor antenna 105 can be connected to the tuner 110 via the antenna connection board 108. In case, to use the indoor antenna 105 in place of the UHF antenna 101, the terminal of the UHF antenna 101 is pulled from the connector of the antenna connection board 108, and the terminal of the indoor antenna 105 is connected to the connector of the antenna connection board 108. Both the UHF antenna 101 and the indoor antenna 105 may be connected at all times to the two connectors of the antenna connection board 108, respectively. In this case, a changeover switch may be operated to connect either the UHF antenna 101 or the indoor antenna 105 to the tuner 110, so that the antenna selected may be used.

The tuner 110 includes a full-segment receiving circuit 111 and a one-segment receiving circuit 112. The full-segment receiving circuit 111 or the one-segment receiving circuit 112 is set to a signal receiving state in accordance with a control signal output from a control block 400. The control block 400 will be described later in detail.

The tuner 110 is operated to select a channel. The program signal of the channel selected in the tuner 110 is demodulated and input to a signal processor 200. The signal processor 200 includes a video signal processing circuit 201 and an audio signal processing circuit 202. The video signal processing circuit 201 decodes an encoded video signal to a base-band video signal. As encoding and decoding schemes, there are the Moving Picture Experts Group (MPEG) and H.264/Advanced Video Coding (AVC) system, etc., for example. The base-band video signal output from the video signal processing circuit 201 is supplied to a display 300.

The audio signal processing circuit 202 acquires an audio stream from the program signal and then decodes the audio stream. The decoded audio signal is supplied to a digital-to-analog converter 203 and converted to an analog audio signal which is supplied to a speaker 204. In the system of FIG. 1, the speaker 204 is shown as a headphone. The headphone can, of course, be replaced by a stationary speaker.

The signal processor 200 can be connected to an external apparatus under the control of the control block 400. The signal processor 200 can be connected by, for example, a high-definition multimedia interface (HDMI) 205 to an external data record/playback apparatus such as an optical disk player, for example a DVD or BD (trademark) player. The signal processor 200 can therefore receive playback signals from the external data record/playback apparatus and process these signals to generate video and audio output signals. Further, the signal processor 200 can transmit the signals used for recording to the external data record/playback apparatus.

Under control of the control block 400, the signal processor 200 also can be connected via a universal serial bus (USB) 206 to a hard disk drive (HDD) 207. The hard disk drive 207 incorporates a battery 208, and can keep operating for two to three hours upon a blackout by using the battery. Moreover, the hard disk drive 207 can supply power from the battery to some other blocks shown in FIG. 1 under the control signal.

The control block 400 includes a main microprocessor unit (hereinafter referred to as “main MPU”) 401 and a sub-microprocessor unit (hereinafter referred to as “sub-MPU”) 402. The main MPU 401 includes an electronic program guide management system (hereinafter referred to as an “EPG management system) 401a, an operating-state control system 401b, and a display-state control system 401c.

The components 400, 401 and 402 and the components 401a, 401b and 401c may be given names other than those specified above. They may be called, for example, “main control circuit”, “sub-control circuit”, “EPG processing circuit”, “operating-state control circuit” and “display-state control circuit”. Alternatively, they may be called “modules” or “blocks”. Their names specified above accord with the functions they perform. Instead, other names may be used, each indicating that two or more components are integrated or combined.

The EPG management system 401a acquires program data through the Internet or the program data contained in a broadcast signal, and generates program list data. The program list data can be stored in a random access memory (hereinafter referred to as “RAM”) 451. Further, the EPG management system 401a can cooperate with the display-state control system 401c to read the program list stored in the RAM 451 and output the same to the display 300. Moreover, the EPG management system 401a can correct and change in periodically the program data stored in the RAM 451.

The RAM 451 may be any memory in which data can be written and from which data can be read, and can therefore be a nonvolatile memory. The RAM 451 may, of course, store various data items (e.g., icons, warning messages, and channel numbers). A read only memory (ROM) 452 is connected to the control block 400, and stores various software items for use in the television receiver 100. The software is extended in, for example, the RAM 451, operating the television receiver 100 in accordance with signals and instructions the user has input.

In response to the state signals generated internally or supplied externally or to operation signals supplied externally, the operating-state control system 401b controls the blocks incorporated in the television receiver 100. The operating-state control system 401b can switch the tuner 110, from the one-segment receiving state to the full-segment receiving state, or vice versa. Further, the operating-state control system 401b can control the signal processing state in the signal processor 200. Still further, the operating-state control system 401b can control color adjustment, luminance adjustment, partial shut-off of power supply, and the like, automatically or manually in accordance with the conditions preset.

The display-state control system 401c can adjust the backlight of the display 300 and control the illumination area of the backlight. The display-state control system 401c can further control the luminance of the video signal, the image magnification and reduction and the motion of a display position.

The sub-MPU 402 includes a power-supply control system 402a and an operation signal system 402b. The operation signal system 402b receives an operation signal transmitted from a remote controller 700 through a remote-control signal receiver 455 and analyzes the operation signal. In accordance with the result of analyzing the operation signal, the operation signal system 402b controls the operating state of the television receiver 100. More precisely, the operation signal system 402b turns on or off the main power supply of the television receiver 100, activates or deactivates the main MPU 401 or gives commands to the sub-MPU 402. Operation signals come from not only the remote-control signal receiver 455, but also from a manual operation unit 456. When the manual operation unit 456 is operated by the user, an operation signal from the manual operation unit 456 is analyzed by the operation signal system 402b.

The power supply system of the television receiver 100 will be described. The commercially available AC power is supplied to a plug 551, and thence to an AC adaptor 552. The AC adaptor 552 rectifies the power, which is input to a power output circuit 500. The power output circuit 500 converts the output of the AC adaptor 552 to various DC voltages. If the AC adaptor 552 is not provided, the power output circuit 500 rectifies the commercially available AC power, generating DC voltages of various values. Moreover, the power output circuit 500 can acquire power from a battery 553. The power output circuit 500 has a DC-to-DC converter 501 and a switch 502. The DC-to-DC converter 501 converts the DC voltage applied from the battery 553 to various DC voltages. Thus, the power output circuit 500 can generate DC voltages of various values.

Under the control of the power-supply control system 402a, the power output circuit 500 can switch the power-use state of the television receiver 100, from the use of commercially available power to the use of battery power, or vice versa. The power-use state can be switched when the switch 502 is controlled by the power-supply control system 402a.

A transceiver 460 is connected to the control block 400. The transceiver 460 includes a short-distance communication device 461. The short-distance communication device 461 can communicate with a mobile terminal 800 via an antenna 462. The transceiver 460 further includes a network communication device 463. The network communication device 463 is connected to a network 610, and can perform data communication with a server 611. The mobile terminal 800 may be one of various types, such as a mobile telephone. The mobile terminal 800 has, at least, a transceiver, a display, an operation unit and a signal processor and is small enough to carry.

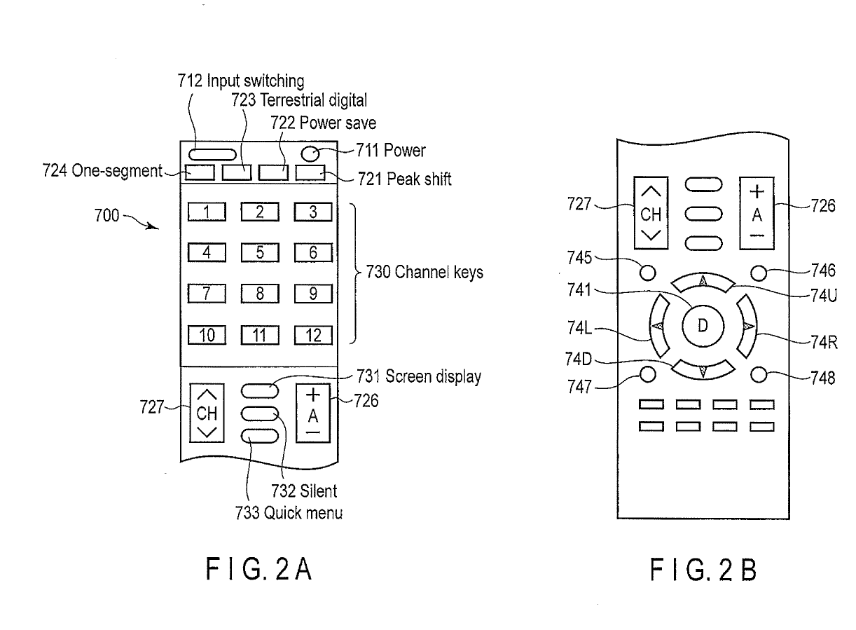

FIG. 2A and FIG. 2B shows the various buttons provided on the remote controller 700. The power button 711 may be pushed to turn on or off the television receiver 100. As the user repeatedly pushes the power button 711, the television receiver 100 is repeatedly turned on and off. Even if television receiver 100 is turned off state, the power output circuit 500 keeps supplying auxiliary power to the sub-MPU 402 and short-distance communication device 461. The sub-MPU 402 and short-distance communication device 461 can therefore receive operation signals from the remote controller 700. The input switching button 712 may be used to switch the television receiver 100 in a state of receiving an input from an external apparatus connected to the television receiver 100.

Assume that the input switching button 712 is repeatedly pushed. Then, the operating state of the television receiver 100 is cyclically changed to the digital-broadcast receiving state, the HDMI-signal receiving state, the video input state and the D-terminal input state. If the input switching button 712 is further pushed, the operating state of the television receiver 100 is changed back to the digital-broadcast receiving state.

The remote controller 700 has a peak-shift button 721, too. The peak-shift button 721 can be used to set the television receiver 100 to a power-save cooperation mode. In the power-save cooperation mode, the television receiver 100 saves the commercially available power (i.e., power supplied from the power generation plant of the electric power company). If the peak-shift button 721 is pushed while the television receiver 100 remains in the standby state, the television receiver 100 is switched to, for example, the battery-driven mode.

While the television receiver 100 is using the commercially available power, the display 300 displays a plug icon at the corner of the screen. While the television receiver 100 is using the battery power, the display 300 displays, at the corner of the screen, a battery icon that indicates the amount of power remaining in the battery 558. Note that the plug icon and the battery icon can have various shapes and can include characters, as long as they inform the user of the type of power supply now used.

The remote controller 700 further has a power-save button 722. When pushed, the power-save button 722 switches the television receiver 100 to a power saving state (or power saving mode). In the power saving mode, the screen of the display 300 becomes dark and the image-quality parameters are changed values, and power is thereby saved. More specifically, when the user pushes the power-save button 722, the luminosity of the backlight is decreased, thereby saving power. At the same time, the image parameters, such as black level, unicolor level and color temperature, are adjusted, displaying an image that is dark but can be seen well. When the power-save button 722 is pushed again, the screen of the display 300 acquires the standard brightness, and the image-quality parameters are changed back to the standard values.

The remote controller 700 also has a terrestrial digital broadcast button 723 and a one-segment button 724. When pushed, the terrestrial digital broadcast button 723 sets the television receiver 100 to the full-segment receiving mode. When pushed, the one-segment button 724 sets the television receiver 100 to the one-segment receiving mode. Once the television receiver 100 has been set to the one-segment receiving mode, the indoor antenna 105 is used to receive a one-segment broadcast signal, as explained with reference to FIG. 1.

The antenna may be automatically switched from the UHF antenna 101 to the indoor antenna 105, or vice versa, by a switch provided on the antenna connection board 108. As shown in FIG. 2A, the remote controller 700 has channel selection buttons 730, which are labeled “1” to “12,” respectively. The remote controller 700 further has a volume button 726 and a channel switching button 727. The volume button 726 is used to adjust the volume of the sound. The volume of the sound is increased when the “+” end of the button 726 is pushed. The volume of the sound is decreased when the “−” end of the button 726 is pushed. Every time the channel switching button 727 is pushed at the upper end (in FIG. 2A), the receiving channel of the TV may be changed to the immediately greater channel of the number. Every time the channel switching button 727 is pushed at the lower end (in FIG. 2A), the receiving channel of the TV may be changed to the immediately smaller channel of the number.

The remote controller 700 has buttons 731, 732 and 733 arranged in a column. If pushed, the button 731 causes the display 300 to display, temporarily, detailed data items such as the name and channel number of the broadcast station transmitting the program now received, the one-segment or full-segment receiving mode, and the type of video and audio data (monaural or stereophonic). If pushed, the button 732 labeled “silence button” causes the speaker 204 to stop outputting sound. If pushed, the button 733 labeled “quick menu” causes the display 300 to display a quick menu. The quick menu includes various image-setting items, sound-setting items, power-saving items and reception-setting items, etc. While looking at the quick menu displayed, the user moves a cursor in the screen of the display 300, to any desired item, and then pushes a select button 741 provided on the remote controller 700, thereby selecting the desired item. The display 300 then displays the item selected, in detail.

The remote controller 700 further has buttons 74L, 74R, 74U and 74D, which the user may control to move the cursor in the screen of the display 300. More precisely, if the buttons 74L, 74R, 74U and 74D are pushed, the cursor moves leftward, rightward, upward and downward, respectively, on the screen of the display 300. The select button 741 may be pushed to determine the desired item the cursor points to on the screen of the display 300.

The remote controller 700 still further has buttons 745, 746 and 747. If the button 745 is pushed, the display 300 will display a menu of image. If the button 746 is pushed, a program table is displayed. If the button 747 is pushed, the television receiver 100 will be set back to the previous operating mode.

<Terrestrial Digital Broadcast Button 723 and One-Segment Button 724>

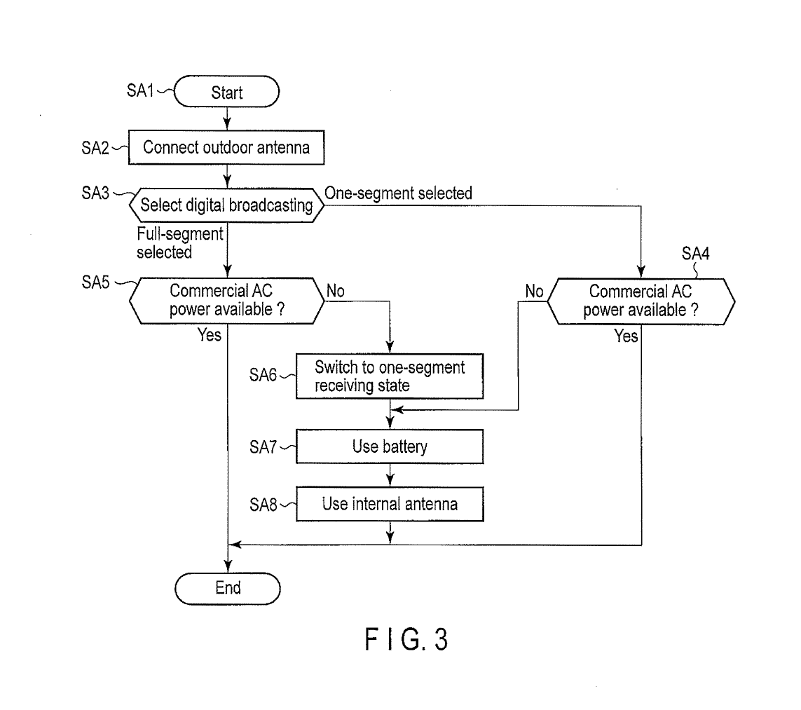

FIG. 3 shows how the television receiver 100 operates when it is switched from the one-segment receiving mode to the full-segment receiving mode, or vice versa. Assume that the receiving mode is switched to the one-segment receiving mode while the external antenna remains connected to the tuner 110 (Steps SA1 to SA3). This switching is achieved by a signal the user has input at the remote controller 700, a signal manually generated, or a signal automatically generated by a timer or in accordance with power-save data.

When the receiving mode is switched to the one-segment receiving mode, it is determined whether the commercially available AC power is supplied to the television receiver 100 (Step SA4). If the commercially available AC power is supplied to the television receiver 100 (YES in Step SA4), the process is terminated while the television receiver 100 remains in the one-segment receiving mode. If the commercially available AC power is not supplied to the television receiver 100 (NO in Step SA4), the process goes to Step SA7, in which the battery 553 is used. Then, the internal antenna 105 is used (Step SA8).

The process then returns to Step SA3, and if the full-segment reception is selected, the television receiver 100 is set to the full-segment receiving mode. In the full-segment receiving mode, it is frequently checked as to whether the commercially available AC power is supplied to the television receiver 100 (Step SA5). As long as the commercially available AC power is supplied to the television receiver 100, the full-segment reception continues. When the supply of the commercially available AC power stops, the television receiver 100 is automatically switched to the one-segment receiving mode (Step SA6). The battery 553 is therefore used (Step SA7), and the internal antenna 105 is used (Step SA8).

The user can thus switch the television receiver 100 to whichever receiving mode, i.e., full-segment receiving mode or one-segment receiving mode. Therefore, if the AC power supply is used, the user may set the television receiver 100 to the one-segment receiving mode, in order to save power.

Whether set in the full-segment receiving mode or the one-segment receiving mode, the television receiver 100 automatically assumes the one-segment receiving state and is battery-driven immediately, when the supply of the commercially available AC power is stopped. If a blackout should occur for some reason, the television receiver 100 would keep operating, giving audio-visual information to the user.

The battery 553 may be recharged at midnight, for example, when the power generation plant is generating more power than is necessary. In this regard, the television receiver 100 can display a recharging menu, which shows various time slots for recharging the battery 553. The user operates the remote controller 700, selecting the cursor on the screen of the display 300, and the select button 741, thereby selecting the desired time slot. Then, the battery 553 will be recharged in the time slot the user has selected, unless a blackout occurs in the time slot selected.

The television receiver 100 is so designed that the battery 553 is never recharged while it is displaying any program. That is, the power output circuit 500 can indeed supply the commercially available AC power to the battery 553, but supplies no AC power to the battery 553 as long as the television receiver 100 displays any program.

If the user pushes the peak-shift button 721, the battery 553 drives the television receiver 100. The battery 553 may be used in a power peak period such as a few hours in a summer afternoon. This use of the battery 553 helps prevent an increase in power consumption in the power peak period. Thus, whether the power peak period can be shifted or not, it is depends on whether the user selects a power peak shift button at an appropriate time.

Upon a blackout, no power is supplied to the booster 102 of the antenna 101, and the display 300 may not display the program. Even in this case, either an attached antenna or the indoor antenna 105 is utilized to achieve the one-segment reception at the event of a blackout. The television receiver 100 can be battery-driven for three hours, more or less.

Various measures can be taken to detect blackouts. The power-supply control system 402a is connected to, for example, a backup capacitor, and can keep operating for a prescribed time even if a blackout takes place. Therefore, the changes in the voltage on the power supply lines and the output of the AC adaptor 552 can be detected.

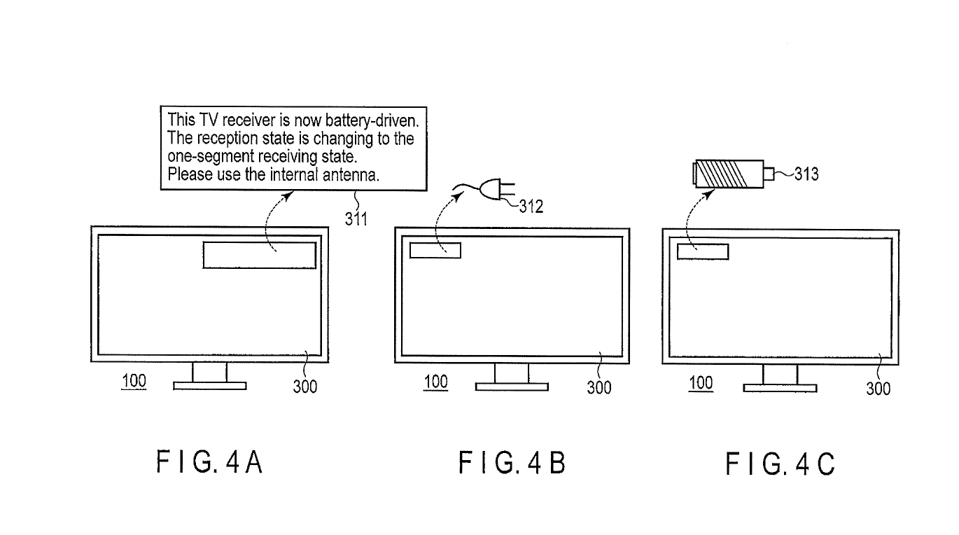

FIG. 4A shows an exemplary guidance message the display 300 displays when the power supply is switched from the commercially available AC power supply to the battery 553. At the time the power supply is switched to the battery 553, or at a blackout, the power supply to the booster 102 of the external antenna 101 is stopped, and the display 300 may no longer display the image. In this case, the display 300 displays a guidance message 311 of “This TV receiver is now battery-driven. The reception state is changing to the one-segment receiving state. Please use the internal antenna.” The term “internal antenna” may be replaced by “attached antenna” or “one-segment receiving antenna”.

FIG. 4B shows a plug-shaped icon 312 the display 300 displays while the television receiver 100 is using the commercially available AC power supply.

FIG. 4C shows a battery-shaped icon 313 the display 300 displays while the television receiver 100 is using the battery 553. The battery-shaped icon 313 indicates the amount of power remaining in the battery 553. (More precisely, the number of slant lines is proportional to the power remaining in the battery 553.)

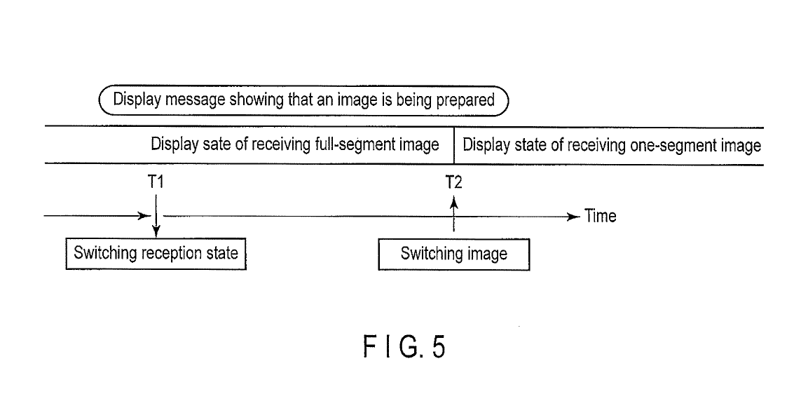

FIG. 5 shows time T1 at which the reception state is switched from the full-segment receiving state to the one-segment receiving state, and time T2 at which the image is actually switched from the full-segment image to the one-segment image. Some time lapses until a one-segment image is displayed after the reception state has been switched from the full-segment receiving state to the one-segment receiving state. Therefore, the full-segment image remains displayed on the screen until the one-segment video data is output. When the one-segment video data is output, the full-segment image is switched to the one-segment image on the screen of the display 300. Until the one-segment video data is output, a message showing this fact may be displayed on the screen of the display 300.

<Peak Shift Button 721 and Power-Save Button 722>

The user may push the peak-shift button 721 to save the commercially available power (supplied from the power generation plant of the electric power company). If the peak-shift button 721 is pushed, the television receiver 100 stops using the commercially available power and starts using the battery 553. If the peak shift-button 721 is pushed while the battery 553 is being used, the television receiver 100 is set to the one-segment receiving state.

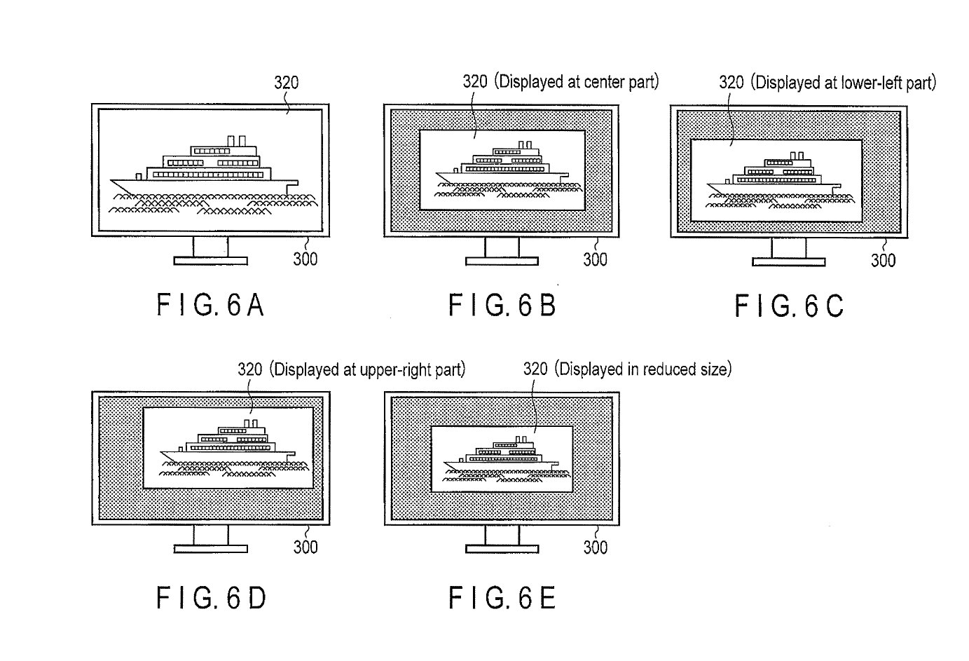

FIG. 6A to FIG. 6E show exemplary images the display 300 displays after the television receiver 100 has been set to the one-segment receiving state. Once set to the one-segment receiving state, the television receiver 100 can display an image 320 on the screen, as shown in FIG. 6A. In this state, the battery 553 is being used. So this state helps to save the power supplied by the electric power company. Further, in order to reduce the consumption of the battery power, the image can be displayed as shown in FIG. 6B, in a small size in, for example, the center part of the screen.

If a high-luminance image 320 of the small size is displayed in the same part of the screen for a long term, the activating time of the high-luminance pixels defining the image 320 will differ from the activating time of the pixels surrounding the image 320, and the activating time of the backlight elements in the region of the image 320 will differ from the activating time of the backlight elements in the region surrounding the high-luminance image 320. Consequently, the screen of the display 300 has a conspicuous line, in some cases, at the boundary between the part where the high-luminance image 320 is displayed and the part where no high-luminance images are displayed. In view of this, the television receiver 100 is designed to move the region of the image 320 of the small size on the screen as shown in FIG. 6B, FIG. 6C or FIG. 6D. The image 320 may be moved at various times, for example, when an advertisement starts, or when a prescribed period is passed, or when a prescribed period is passed then an advertisement starts.

Further, the size of the image 320 displayed can be more reduced as shown in FIG. 6E, for the purpose of saving power.

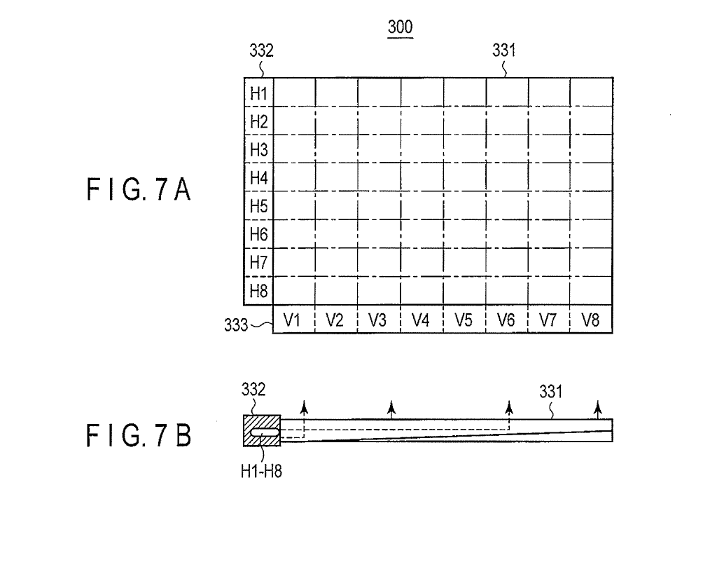

FIG. 7A and FIG. 7B show the structure of the backlight unit of the display 300, which can change the position and size of the display area of the display 300. The display 300 has a light guide plate 331. The backlight unit has horizontal light source elements 332 and vertical light source elements 333. The light beams emitted from the light source elements 332 and 333 are reflected in the light guide plate 331 and guided toward the front surface of the light guide plate 331, thus functioning as a backlight. The light source elements 332 and 333 are, for example, light-emitting diodes (LEDs). The light beams emitted from the light source elements 332 and 333 are diffused in the light guide plate 331. Therefore, light of uniform intensity emerges from the front surface of the light guide plate 331.

More specifically, the horizontal light source elements 332 are eight light sources H1 to H8, and the vertical light source elements 333 are eight light sources V1 to V8. If the light sources H1, H8, V1 and V8 are turned off, the peripheral part of the light guide plate 331 will appear dark. The boundary between the dark region and the bright region is not clear-cut. Nonetheless, the backlight region can be controlled.

Hence, in order to display such images 320 as shown in FIG. 6B to FIG. 6E, the signal processor 200 outputs a video signal so that the display 300 may display an image 320 surrounded by a dark frame at zero-luminance level. If the backlight unit of the display 300 operates, displaying such an image as shown in FIG. 6B, 6C, 6D or 6E, more power can be saved than otherwise.

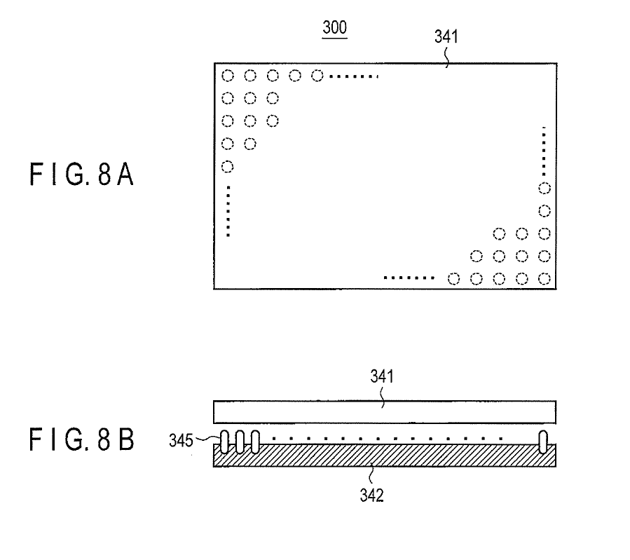

FIG. 8A and FIG. 8B show another structure the backlight unit of the display 300 may have. The display 300 has a glass substrate 341 and a substrate 342 arranged at the back of the glass substrate 341. On the substrate 342, light-emitting elements (LEDs) are arranged, in a two-dimensional pattern. The light-emitting elements can be turned on and off, in units of groups each consisting of the same number of light-emitting elements. A backlight drive circuit (not shown) can drive any selected group of light-emitting elements. A light diffusion layer is formed on the back of the glass substrate 341, and light therefore emerges from the glass substrate 341 with uniform intensity. As a result, the boundary between any bright region and any dark region is not always clear on the entire glass substrate 341. The backlight region can be controlled, nevertheless.

In order to display such an image 320 as shown in FIG. 6B, 6C, 6D or 6E, the signal processor 200 outputs a video signal containing data representing a dark frame at zero-luminance level. If the display 300 displays an image 320 of this type (shown in FIG. 6B, 6C, 6D or 6E), its backlight unit consumes less power than otherwise.

The backlight unit of the display 300 is not limited to the configuration described above. The backlight unit may have a plurality of fluorescent lamps instead. Further, the number of segments into which the display region is divided is not limited to the number specified above. The number of segments can be changed as needed, in the same manner as described above.

As stated above, the backlight region can be controlled. In order to save power, the backlight region may be controlled in terms of illumination intensity, thereby to save power. To be more specific, the illumination intensity of the entire backlight region may be decreased, in order to reduce the power consumption in the backlight unit. The illumination intensity of the backlight region may be changed to various values in step by step. Moreover, the backlight region can, of course, be changed in both size and illumination intensity.

Displays having a large screen have been developed for use in television receivers. The light sources used in these displays are, for example, fluorescent lamps or light-emitting elements (e.g., LEDs, organic electroluminescent diodes or plasma display).

To save power in the large-screen display of the television receiver will greatly contribute to power saving in society. To switch the reception state of the television receiver, from the full-segment receiving state to the one-segment receiving state, will also save much power.

The television receiver 100 can perform the operations described above. More precisely, the television receiver 100 can perform various combinations of operations, in accordance with the application program provided in the control block 400.

In the one-segment receiving state, the control block 400 can set the display 300 supplied with the video signal output from the signal processor 200, to a full-screen display state. In another embodiment, the control block 400 can, in the one-segment receiving state, set the display 300 supplied with the video signal output from the signal processor 200, to a partial-screen display state, and then turn off some of the light-emitting elements of the backlight unit. In still another embodiment, the control block 400 can, in the one-segment receiving state, set the display 300 supplied with the video signal output from the signal processor 200, from the full-screen display state to the partial-screen display state, and then turn off some of the light-emitting elements of the backlight unit, when the power in the battery 553 decreases to a prescribed value. In another embodiment, the control block 400 can, in the one-segment receiving state, set the display 300 supplied with the video signal output from the signal processor 200, to the full-screen display state or the partial-screen display state, and turn off some of the light-emitting elements of the backlight unit, thereby to set the display 300 to one display state in response to the selection signal the user has input. Further, the display 300 can display a message, prompting the user to operate the remote controller 700.

Moreover, in another embodiment, the tuner 110 can receive a broadcast signal from the external antenna 101 and the power output circuit 500 can supply power to the booster 102 of the external antenna 101, if the reception state has been set to the one-segment receiving state. In still another embodiment, the tuner 110 can receive the broadcast signal from the external antenna 101 and the power output circuit 500 can stop supplying power to the booster 102 of the internal antenna 105, if the reception state has been set to the one-segment receiving state. In a further embodiment, tuner 110 can receive a broadcast signal from the attached antenna and the power output circuit 500 can stop supplying power to the booster 102 of the external antenna 101, if the reception state has been set to the one-segment receiving state. In any of these cases, the antenna may be switched automatically, or the user may switch the antenna in accordance with the instruction the display 300 shows.

Moreover, in still another embodiment, the image 320 shown in FIG. 6A to FIG. 6E can be changed in size in accordance with the power remaining in the battery 553 or in response to an instruction the user has input. In addition, the audio-system circuits may be turned off, while keeping the video signal active, thereby to save power. Conversely, the video-system circuits may be turned off, while keeping the audio signal active, thereby to save power.

The television receiver 100 according to any one of the embodiments described above can save power, while performing all of its functions. Further, even upon a blackout, the television receiver can save power, while performing all of its functions. Moreover, the television receiver 100, which has not only ordinary functions, but also a power-saving function, may be bought by consumers willing to save power, ultimately reducing the power consumption in society.

In order to save power, the display 300 may be controlled to set at least one-third (⅓) of the screen of the display 300 to low luminance in the one-segment receiving state, and display the image in the remaining part of the screen. In this case, those of the light-emitting elements of the backlight unit, which lie behind one-third (⅓) of the screen, are turned off. Moreover, the image so displayed can move, with time, over the entire screen. Said remaining part of the screen can be changed in size in accordance with how much power should be saved in the television receiver 100.

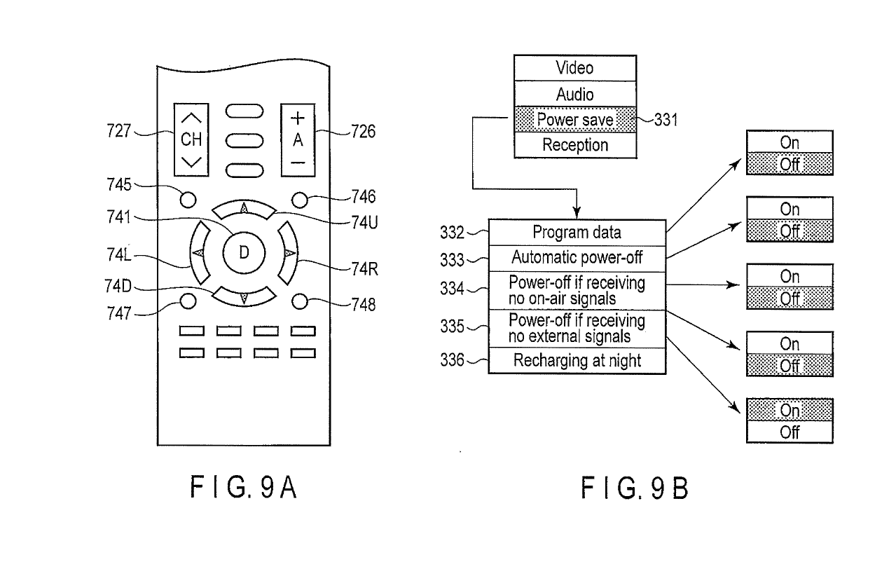

FIG. 9A shows the remote controller 700 having various buttons, and FIG. 9B shows an exemplary power-saving menu the user may use to save power in the television receiver 100. If the user pushes the quick menu button 733, the display 300 displays the quick menu showing four items, i.e., “video setting”, “audio setting”, “power-save setting” and “receiver setting”. The user pushes the button 74U or button 74D, moving the cursor to the desired item, and then pushes the select button 741, selecting the desired item. Assume that the user moves the cursor to, for example, the power-save setting 331 and then pushes the select button 741. Then, the display 300 displays the menu of the next layer, which consist of “program data acquisition”, “automatic power-off”, “off to no on-air signal”, “off to no external input” and “battery recharging at night”. If the user selects one of these menu items, the display 300 displays an on-button and an off-button beside the menu item selected.

If the user moves the cursor to, for example, “program data acquisition (EPG data)”, an on-button and an off-button are displayed beside “program data acquisition”. The user operates the button 74U or 74d, moving the cursor to, for example, “on-button”, and then pushes the select button 741. In this case, the television receiver 100 acquires a digital broadcast program while the power switch of the television receiver 100 remains off (that is, while the receiver 100 remains in the standby state). If the user selects “off-button”, the television receiver 100 will acquire no program data.

Assume that the cursor is moved to “automatic power-off”. Then, an on-button and an off-button are displayed beside “automatic power-off”. The user operates the button 740 or 74d, moving the cursor to, for example, “on-button”, and then pushes the select button 741. In this case, the television receiver 100 stops receiving power and is turned off, assuming the standby state, if it remains not operated at all for three hours. If the user selects “off-button”, the television receiver 100 keeps receiving power even if it remains not operated at all for three hours.

Further assume that the cursor is moved to “off to no on-air signal”. Then, an on-button and an off-button are displayed beside “off to no on-air signal”. The user operates the button 74U or 74d, moving the cursor to, for example, “on-button”, and then pushes the select button 741. In this case, the television receiver 100 stops receiving power, and assumes the standby state if it receives no broadcast signals for about 15 minutes. If the user selects “off-button”, the television receiver 100 keeps receiving power even if it keeps receiving no signals.

Assume that the cursor is moved to “off to no external input”, Then, an on-button and an off-button are displayed beside “off to no external input”. The user operates the button 74U or 74d, moving the cursor to, for example, “on-button”, and then pushes the select button 741. If the television receiver 100 keeps receiving no signals for 15 minutes in an external-input selecting mode, the television receiver 100 stops receiving power, and assumes the standby state. If the user selects “off-button”, the television receiver 100 keeps receiving power even if it keeps receiving no signals.

Assume that the cursor is moved to “battery recharging at night”. Then, an on-button and an off-button are displayed beside “battery recharging at night”. The user operates the button 74U or 74d, moving the cursor to, for example, “on-button,” and then pushes the select button 741. In this case, the battery 553 is automatically recharged, for example, from 10:00 PM to 9:00 AM (if the television receiver 100 is in the standby state). If the user moves the cursor to “off-button” and pushes the select button 741, the battery 553 is set to be recharged when the television receiver 100 is in the standby state.

External power supply control by the above-described television receiver (a case in which external power is supplied or not supplied depending on a condition) and charging control of the battery 553 by the external power (a case in which the battery is charged or not charged depending on the condition) will be described. Note that the external power supply control and charging control to be described here can be implemented by combining the above-described various operations, processes, and control modes, or can be implemented independent of the above-described various operations, processes, and control modes.

The above-described power output circuit (power supply module) of the television receiver supplies, to a power supply destination, externally supplied external power (power supplied from the plug 551) or battery power from the battery 553 which is configured to be chargeable by external power. The sub-MPU 402 (power-supply control system 402a) supplies external power in response to an external power-drive instruction (when the power button 711 is turned on), and stops supplying external power and supplies battery power instead in response to a battery-drive instruction (when the peak-shift button 721 is turned on). The sub-MPU 402 (power-supply control system 402a) can monitor the voltage of the battery power (whether the voltage is kept to be greater than or equal to a reference voltage), and detect the voltage of the battery power which is less than the reference voltage (for example, 7 V). Upon detecting the voltage of the battery power which is less than the reference voltage, the sub-MPU 402 (power-supply control system 402a) stops supply of battery power, and controls external power supply and battery charging by the external power according to a control condition (to be described in detail later).

When, for example, the television receiver is battery-driven using the battery power, the sub-MPU 402 (power-supply control system 402a) selectively executes one of the following control modes according to a control condition upon detecting a voltage of the battery power which is less than the reference voltage, as described above. Alternatively, the main MPU 401 outputs display information for displaying a setting menu (GUI), thereby enabling the user to select one of the following four control modes through the setting menu.

(1) The sub-MPU 402 (power-supply control system 402a) turns off the power (supply of the external power and battery power) according to a first control condition (to be described in detail later). That is, the power-supply control system 402a effects control to achieve a first state in which the battery is not charged while stopping external power supply according to the first control condition.

In the first state, the power-supply control system 402a does not restart supply of external power in response to an external power-drive instruction. Alternatively, in the first state, the power-supply control system 402a may restart supply of external power in response to the external power-drive instruction. Assume that one of the two control modes is automatically selected based on settings.

Note that if, while the battery power with the voltage greater than or equal to the reference voltage is supplied, the power-supply control system 402a turns off the power of the television receiver in response to an external power-drive instruction (when the power button 711 is pushed), it restarts supply of external power in response to a subsequent external power-drive instruction.

(2) The sub-MPU 402 (power-supply control system 402a) turns off the power (supply of the external power and battery power) but restarts charging according to a second control condition (to be described in detail later). That is, the power-supply control system 402a effects control to achieve a second state in which the battery is charged while stopping external power supply according to the second control condition.

(3) The sub-MPU 402 (power-supply control system 402a) switches to the AC power supply (external power supply) (although output of a video and the like to be viewed continues) but does not charge the battery according to a third control condition (to be described in detail later). That is, the power-supply control system 402a effects control to achieve a third state in which it starts external power supply according to the third control condition and the main MPU 401 continues outputting a video and the like while the battery is not charged.

Note that the main MPU 401 may continue outputting a video and the like in a power saving mode. The main MPU 401 then executes at least one of power saving operations such as an operation of decreasing the luminance of the illumination of the backlight of the display 300, an operation of reducing an illumination area of the backlight, and an operation of decreasing the volume.

(4) The sub-MPU 402 (power-supply control system 402a) switches to the AC power supply (external power supply) (although output of a video and the like to be viewed continues), and also charges the battery according to a fourth control condition (to be described in detail later). That is, the power-supply control system 402a effects control to achieve a fourth state in which it starts external power supply according to the fourth control condition and the main MPU 401 continues outputting a video and the like while the battery is charged.

Note that the main MPU 401 may continue outputting a video and the like in a power saving mode.

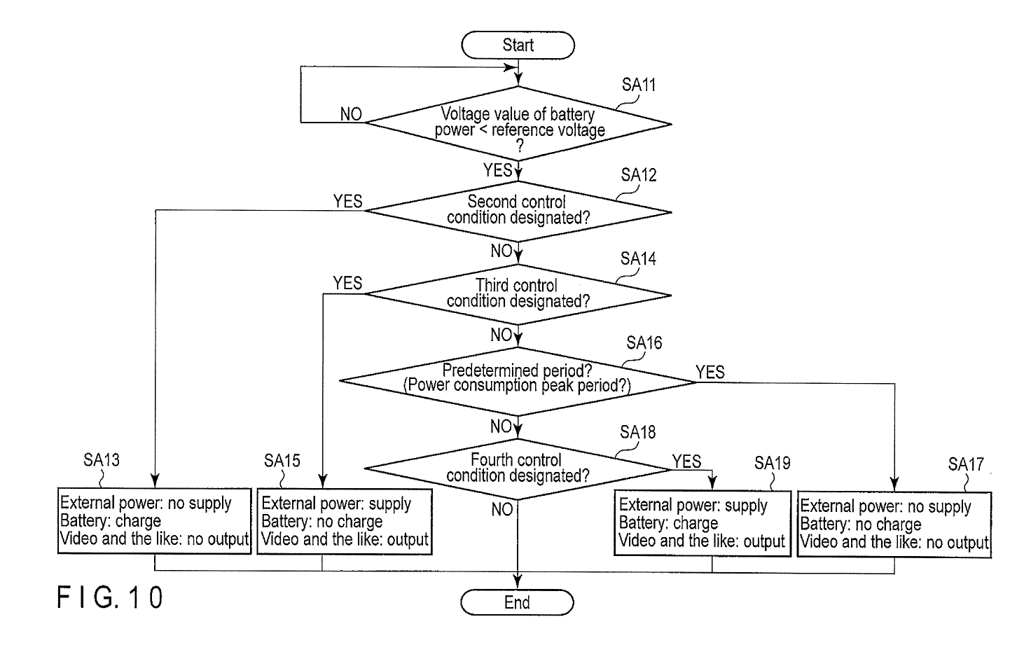

The above-mentioned first to fourth control conditions will be explained with reference to FIG. 10.

(a) If the sub-MPU 402 (power-supply control system 402a) detects that the voltage of the battery power is less than the reference voltage (YES in step SA11), and the current time falls within a predetermined period (for example, a power consumption peak period) (YES in step SA16), it is determined that the first control condition has been satisfied, and control is made in the above-described first state (step SA17). The above predetermined period may be set (designated) by the user, or may be determined based on power consumption peak period information acquired through the Internet or contained in a broadcast signal.

(b) If the sub-MPU 402 (power-supply control system 402a) detects that the voltage of the battery power is less than the reference voltage (YES in step SA11), and the user has designated the second control condition (YES in step SA12), control is made in the second state in which the battery is charged while stopping external power supply according to the second control condition designated by the user (step SA13).

Alternatively, if the sub-MPU 402 (power-supply control system 402a) detects that the voltage of the battery power is less than the reference voltage (YES in step SA11), and the user has designated the third control condition (YES in step SA14), control is made in the third state in which external power supply starts and the battery is not charged according to the third control condition designated by the user (step SA15).

(c) The sub-MPU 402 (power-supply control system 402a) detects that the voltage of the battery power is less than the reference voltage (YES in step SA11), the current time falls outside the predetermined period (NO in step SA16), and the user has designated the fourth control condition (YES in step SA18), control is made in the fourth state in which external power supply starts and the battery is charged (step SA19).

The sub-MPU 402 (power-supply control system 402a), for example, can set to be unable to select one or more of the above-described second, third, and fourth control conditions during the predetermined period. The main MPU 401, for example, grays out the unselectable control conditions in the setting menu (GUI) during the predetermined period.

A case in which the apparatus is in a battery-drive disable state although a battery-drive instruction has been received (the peak-shift button 721 has been turned on) will be described next. The battery-drive disable state indicates a state in which the sub-MPU 402 (power-supply control system 402a) is detecting that the voltage of the battery power is less than the reference voltage or the battery is not incorporated.

In response to a battery-drive instruction in the battery-drive disable state, the sub-MPU 402 (power-supply control system 402a) selectively executes one of the following control modes depending on, for example, a period. Alternatively, the main MPU 401 outputs display information for displaying a setting menu (GUI), thereby enabling the user to select one of the following control modes through the setting menu.

(1) The sub-MPU 402 (power-supply control system 402a) turns off the power (supply of the external power and battery power). That is, the power-supply control system 402a effects control to achieve a stopped state in which the battery is not charged while stopping external power supply.

The power-supply control system 402a, for example, effects control to achieve the stopped state during the predetermined period (for example, a power consumption peak period).

(2) The sub-MPU 402 (power-supply control system 402a) continues the external power supply, and the main MPU 401 controls output of information for displaying a battery-drive disable state.

The power-supply control system 402a, for example, effects control to display the battery-drive disable state outside the predetermined period.

The television receiver can always switch to a battery-drive mode to operate by the battery power even outside the predetermined period (power consumption peak period). In this case, during the predetermined period, it may be impossible to supply necessary power because the battery is exhausted. If, in such case, the television receiver operates by battery power while charging the battery by external power, it consumes a power higher than that consumed when it operates only by external power. As described above, for example, the television receiver (power-supply control system 402a) executes the above-described external power-drive or charging control.

The television receiver (power-supply control system 402a) transits to an operation by the battery power in response to one battery-drive instruction (when the peak-shift button 721 is turned on), and then transits to an operation by the external power in response to one battery-drive instruction (when the peak-shift button 721 is turned on).

Depending on the condition, however, the following operation is also possible. For example, the television receiver (power-supply control system 402a) transits to an operation by the battery power in response to one battery-drive instruction (when the peak-shift button 721 is turned on). When the television receiver (power-supply control system 402a) receives one battery-drive instruction (the peak-shift button 721 is turned on) during the predetermined period (power consumption peak period), transition to an operation by the external power is prohibited. That is, the television receiver can transit to an operation by battery power at any time but is not always allowed to transit to an operation by external power. This enables to suppress power consumption during the predetermined period.

Note that a case in which even if the television receiver receives one battery-drive instruction (the peak-shift button 721 is turned on) during the predetermined period (power consumption peak period), it cannot transit to an operation by external power has been described. However, if, for example, the user requests to display the setting menu through the operation unit such as the remote controller 700, and instructs to transit to an operation by external power through the setting menu, the television receiver (power-supply control system 402a) allows to transit to the operation by external power.

Broadcast program recording control for reducing the power consumption will be explained.

Under the same condition (for example, when the same operation time is assumed), the amount of power consumed to output (display) a broadcast program is larger than that consumed to record the broadcast program. The television receiver (MPU 401), therefore, can switch from output (display) of the broadcast program to recording of the broadcast program according to the control condition.

For example, the television receiver (MPU 401) effects control to stop output (display) of the broadcast program during the predetermined period, and to record the broadcast program instead. In this case, before displaying is stopped, the television receiver (MPU 401) displays, by OSD, guidance indicating that viewing of the broadcast program will be switched to recording of the broadcast program because the current time falls within the predetermined period. After that, the signal processor 200 stops outputting (displaying) the broadcast program during the predetermined period, and records the broadcast program in the HDD 207 instead. The signal processor 200, for example, continues recording the program until the predetermined period elapses. Alternatively, the signal processor 200 continues recording the program until the program being currently broadcast (viewed) ends.

If the tuner 110 is configured to be able to simultaneously select a plurality of channels (for example, the tuner 110 formed by a plurality of tuners for the plurality of channels), the signal processor 200 can stop outputting (displaying) broadcast programs during the predetermined period, and record the respective broadcast programs of the plurality of channels in the HDD 207 instead. In this case, before displaying is stopped, the television receiver (MPU 401) displays, by OSD, guidance indicating that viewing of the broadcast programs will be switched to recording of the broadcast programs because the current time falls within the predetermined period. After that, the signal processor 200 stops outputting (displaying) the broadcast programs during the predetermined period, and records the respective broadcast programs of the plurality of channels in the HDD 207 instead.

With this processing, the user can view any one of the broadcast programs of the plurality of channels during the predetermined period when the predetermined period elapses (time-shift playback).

Furthermore, if, in the operation by the battery power during the predetermined period, the television receiver (MPU 401 or power-supply control system 402a) detects that the voltage of the battery power is less than the reference voltage (according to, for example, the third control condition), it can stop battery power supply, start external power supply, stop outputting (displaying) a broadcast program, and record the broadcast program in the HDD 207 instead. In this case, before displaying is stopped, the television receiver (MPU 401) displays, by OSD, guidance indicating that viewing of the broadcast program will be switched to recording of the broadcast program because the current time falls within the predetermined period. After that, the signal processor 200 stops outputting (displaying) the broadcast program during the predetermined period, and records the broadcast program in the HDD 207 instead. Note that, at this time, it is possible to control to Charge or not to charge the battery.

The television receiver (EPG management system 401a) can acquire program information through the Internet or program information contained in a broadcast signal, create program list data, and store it in the RAM 451. The EPG management system 401a can cooperate with the control operation of the display-state control system 401c to read out the program list stored in the RAM 451 and to output it to the display 300. The user uses the operation unit such as the remote controller 700, and selects an item for a target program while viewing the program list, thereby making a reservation of recording or viewing of the target program. The control block 400 stores recording reservation information and viewing reservation information in a non-volatile memory or the like.

The television receiver (power-supply control system 402a), for example, refers to the recording reservation information, and effects control to charge the battery 553 outside a recording reservation period. The television receiver (power-supply control system 402a), for example, reserves enough time of 24 hours, outside the recording reservation period, to charge the battery 553.

Furthermore, the television receiver (power-supply control system 402a) refers to the viewing reservation information, and effects control to charge the battery 553 outside a viewing reservation period. The television receiver (power-supply control system 402a), for example, reserves enough time of 24 hours, outside the viewing reservation period, to charge the battery 553.

In this embodiment, various controls, processes, and operations by the television receiver have been described. The various control modes, processes, and operations described in this embodiment are applicable to a battery-operable computer or the like.

It is possible to obtain, for example, the following effects in this embodiment.

(1) A large stationary TV which operates by battery power or the like can execute efficient power control.

(2) An operation unit such as a remote controller enables to execute a peak-shift function by one touch.

(3) Using a peak-shift button provided on the operation unit such as a remote controller, the user can switch to a battery-drive mode at an arbitrary time, and can execute appropriate power control and charging control when a shortage of the remaining battery level occurs.

(4) Using the peak-shift button provided on the operation unit such as a remote controller, the user switches to a battery-drive mode at an arbitrary time, and switches from video output to video recording (processing associated with the video output is stopped) when a shortage of the remaining battery level occurs, thereby enabling to view a program later while suppressing power consumption.

According to at least one of the above-described embodiments, it is possible to provide a power control apparatus and power control method for selecting external power supply according to a condition, and executing battery charging according to the condition.

The various modules of the embodiments described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A power control apparatus comprising:
a power supply module configured to supply, to a power supply destination, externally supplied external power or battery power from a battery which is configured to be chargeable by the external power; and
a controller configured to supply the battery power in response to a battery-drive instruction, stop, upon detecting that a voltage of the battery power is less than a reference voltage, supply of battery power, and control supply of the external power and charging of the battery by the external power according to a control condition.

2. The apparatus of claim 1, wherein the controller is configured to supply the external power in response to an external power-drive instruction, and to stop supply of external power and supply the battery power in response to the battery-drive instruction.

3. The apparatus of claim 2, wherein the controller is configured to control to be in a first state in which the battery is not charged while stopping supply of external power according to a first control condition.

4. The apparatus of claim 3, wherein the controller is configured not to restart supply of external power in response to the external power-drive instruction in the first state.

5. The apparatus of claim 3, wherein the controller is configured to restart to supply the external power in response to the external power-drive instruction in the first state.

6. The apparatus of claim 2, wherein the controller is configured to control to achieve a second state in which the battery is charged while stopping supply of external power according to a second control condition.

7. The apparatus of claim 2, wherein the controller is configured to control to achieve a third state in which supply of external power starts and the battery is not charged according to a third control condition.

8. The apparatus of claim 2, wherein the controller is configured to control to achieve a fourth state in which supply of external power starts and the battery is charged according to a fourth control condition.

9. The apparatus of claim 3, wherein the controller is configured to stop, upon detecting that a voltage of the battery power is less than the reference voltage during a predetermined period, supply of battery power, and to control to achieve the first state according to the first control condition.

10. The apparatus of claim 9, wherein the controller is configured to control to achieve a second state in which the battery is charged while stopping, upon detecting that a voltage of the battery power is less than the reference voltage, supply of external power according to a second control condition designated by a user.

11. The apparatus of claim 9, wherein the controller is configured to control to achieve a third state in which, upon detecting that a voltage of the battery power is less than the reference voltage, supply of external power starts and the battery is not charged according to a third control condition designated by a user.

12. The apparatus of claim 2, wherein the controller is configured to continue supply of external power in response to the battery-drive instruction in a battery-drive disable state in which it is detected that a voltage of the battery power is less than the reference voltage or the battery is not incorporated.

13. The apparatus of claim 12, wherein the controller is configured to control, in response to the battery-drive instruction in the battery-drive disable state, output of information for displaying the battery-drive disable state.

14. The apparatus of claim 12, wherein the controller is configured to continue supply of external power in response to the battery-drive instruction in the battery-drive disable state during a first period, and to stop supply of external power in response to the battery-drive instruction in the battery-drive disable state during a second period.

15. The apparatus of claim 1, comprising:
a display configured to display a video,
wherein the power supply module is configured to supply the external power or the battery power to the display for the display to display the video.

16. The apparatus of claim 1, wherein the controller is configured to change video output to video recording during a predetermined period.

17. The apparatus of claim 7, wherein the controller is configured to start to supply the external power, and to change video output to video recording according to the third control condition.

18. The apparatus of claim 16, wherein the controller is configured to output display information for displaying a fact that video output will be changed to video recording, and to change video output to video recording.

19. The apparatus of claim 1, wherein the controller is configured to charge the battery outside a video recording period based on video recording reservation information.

20. A power control method comprising:
supplying, in response to a battery-drive instruction, to a power supply destination, battery power from a battery which is configured to be chargeable by external power; and
stopping, upon detecting that a voltage of the battery power is less than a reference voltage, supply of battery power, and controlling supply of the external power and charging of the battery by the external power according to a control condition.
